(19) United States
(12) Patent Application Publication
(10) Pub. No.: US 2020/0134512 A1
(43) Pub. Date: Apr. 30, 2020

(54) KNOWLEDGE BASE CONTENT DISCOVERY

(71) Applicant: Nutanix, Inc., San Jose, CA (US)

(72) Inventors: Raviteja MEESALA, Bengaluru (IN); Mark Albert CHAMNESS, Menlo Park, CA (US)

(73) Assignee: Nutanix, Inc., San Jose, CA (US)

(21) Appl. No.: 16/175,737

(22) Filed: Oct. 30, 2018

(51) Int. Cl. G06N 99/00; G06N 7/00; G06F 17/30; G06F 17/27

(52) U.S. Cl. CPC G06N 99/005; G06F 17/2785; G06F 17/30342; G06N 7/005

(57) ABSTRACT

Rapid knowledge base discovery techniques. A database describes associations between knowledge base articles and closed problem cases. In periodic batch operations, the associations are used to generate solution probability predictors, each of which predictor corresponds to a probability that a particular knowledge base article was used to resolve a particular problem or case. The solution probability predictors comprise probability predictor parameter values associated with the set of words that occur in closed customer problem cases. A specialized data structure is populated with the probability predictor parameter values. When a new active customer problem case is opened, a set of words pertaining to the new, active case is constructed. The active case words are used with the specialized data structure to generate a probability value for each of a set of knowledge base articles. The knowledge base articles having the highest probability values are identified and presented in an ordered list.

### FIELD

This disclosure relates to high-performance computing, and more particularly to techniques for accurately matching knowledge base content to natural language problem descriptions.

### BACKGROUND

In the digital age, users of computing systems report “problems” to a “helpdesk” by writing a problem description and/or by making a telephone call to the helpdesk. Support personnel in turn read the problem description and/or listen to the problem that is being reported. The support personnel are expected to respond with a solution in real time (e.g., while the caller is on the phone). To aid the support personnel in determining a solution from a problem description, a corpus of previously-proven solutions is made available to the support personnel.

For example, in the context of technical support for hardware and software computer products, providers of such hardware and software computer products may offer a variety of channels to deliver helpdesk and other problem resolution support to the users of the systems. As examples, a user might be able to receive support for a particular technical support issue by interacting with a set of frequently asked questions (FAQs), and/or an online support forum, and/or a customer service representative via email, chat, phone, etc., and/or a knowledge base of problem/solution articles. In at least the latter two of the foregoing options, some computer-aided mechanism might be implemented in the computing system to identify knowledge base content that is relevant to a particular customer problem. For example, a customer service representative (e.g., support engineer) might want to view relevant knowledge base content (e.g., knowledge base articles) when communicating with the user about a particular case. As another example, a user might desire to view the most pertinent knowledge base articles as a result of entering various search terms into a knowledge base query/search capability implemented in the computing system.

Various approaches to implementing the aforementioned computer-aided knowledge base content identification mechanism are possible. One approach matches certain words that describe a particular active case (e.g., derived from a case email or chat transcript) to a corpus of knowledge base articles. However, this approach very frequently yields inaccurate or irrelevant results, often returning inaccurate or irrelevant results often as frequently as 80% of the time. As an example, while a particular knowledge base article might comprise a set of words that are similar to the set of words that describes an active case, the article might pertain to an issue that is unrelated to the case.

To address such inaccuracies, another approach might first compare the words of a particular active case to the words associated with a set of closed (e.g., resolved) cases. The results of the word comparisons are then considered to quantify the similarity of the active case to each of the closed cases. The knowledge base articles that were used to help solve the most similar (e.g., as determined by a similarity ranking) closed cases are identified. With this approach, the resulting list of identified knowledge base content is far more likely to be at least pertinent to solving the active case. Since identifying correct knowledge base articles quickly serves to save time for both the customer service representative and the user, new techniques are needed.

Unfortunately, when mature and prolific computing systems have thousands of knowledge base articles that cover tens of thousands of historical customer-reported problems, and when each active support case might comprise a few thousand words, the computing resources consumed by the foregoing similarity-driven approaches to identifying relevant knowledge base content can be overwhelming. Furthermore, as the number of users of such computing systems continues to grow (e.g., to tens of thousands of users or more), the latency associated with identifying relevant knowledge base content (e.g., to a user or support engineer) can increase commensurately, negatively impacting the user experience. What is needed is a technological solution for quickly matching articles in a knowledge base to customer problems.

### SUMMARY

The present disclosure describes techniques used in systems, methods, and in computer program products for knowledge base content discovery, which techniques advance the relevant technologies to address technological issues with legacy approaches. More specifically, the present disclosure describes techniques used in systems, methods, and in computer program products for discovery of relevant knowledge base articles from a large knowledge base. Certain embodiments are directed to technological solutions for populating a specialized data structure with solution probability predictor parameter values to quickly identify knowledge base articles with the highest probability of addressing a particular customer problem.

The disclosed embodiments modify and improve over legacy approaches. In example embodiments, the herein-disclosed techniques provide technical solutions that address the technical problems attendant to quickly matching relevant knowledge base articles to a customer support case. Such technical solutions relate to improvements in computer functionality. Various applications of the herein-disclosed improvements in computer functionality serve to reduce the demand for computer memory, reduce the demand for computer processing power, reduce network bandwidth use, and reduce the demand for inter-component communication. For example, when performing computer operations that address the various technical problems pertaining to matching knowledge base articles to a customer support case, both memory usage and CPU cycles demanded are significantly reduced as compared to the memory usage and CPU cycles that would be needed but for practice of the herein-disclosed techniques for populating a specialized data structure with solution probability predictor parameter values. Strictly as one example, the ordered combination of steps of the embodiments serve in the context of practical applications that perform steps for populating a specialized data structure with solution probability predictor parameter values so as to be able to quickly identify knowledge base articles that correspond to a particular customer support case.

Some embodiments disclosed herein use techniques to improve the functioning of multiple systems within the disclosed environments, and some embodiments advance peripheral technical fields as well. As specific examples, use of the disclosed computer equipment, networking equipment, and constituent devices within the shown environments as described herein and as depicted in the figures provide advances in the technical field of database table manipulation as well as advances in various technical fields related to developing predictive models in the area of machine intelligence.

Further details of aspects, objectives, and advantages of the technological embodiments are described herein, and in the drawings and claims.

### BRIEF DESCRIPTION OF THE DRAWINGS

The drawings described below are for illustration purposes only. The drawings are not intended to limit the scope of the present disclosure.

FIG. 1 illustrates a computing environment in which embodiments of the present disclosure can be implemented.

FIG. 2 depicts a knowledge base content discovery technique as implemented in systems that facilitate real-time discovery of knowledge base articles from a large customer support knowledge base, according to an embodiment.

FIG. 3 illustrates a block diagram of a system that facilitates real-time discovery of knowledge base articles from a large customer support knowledge base, according to an embodiment.

FIG. 4 presents a solution probability predictor generation technique as implemented in systems that facilitate real-time discovery of knowledge base articles from a large customer support knowledge base, according to an embodiment.

FIG. 5 presents a knowledge base article ranking technique as implemented in systems that facilitate real-time discovery of knowledge base articles from a large customer support knowledge base, according to an embodiment.

FIG. 6 presents a customer support center use scenario as implemented in systems that facilitate real-time discovery of knowledge base articles from a large customer support knowledge base, according to some embodiments.

FIG. 7 depicts system components as arrangements of computing modules that are interconnected so as to implement certain of the herein-disclosed embodiments.

FIG. 8A, FIG. 8B, and FIG. 8C depict virtualized controller architectures comprising collections of interconnected components suitable for implementing embodiments of the present disclosure and/or for use in the herein-described environments.

### DETAILED DESCRIPTION

Embodiments in accordance with the present disclosure address the problem of quickly and accurately matching knowledge base articles to a customer support case. Some embodiments are directed to approaches for populating a specialized data structure with solution probability predictor parameter values to accurately identify knowledge base articles with the highest probability of addressing a particular customer support case. The accompanying figures and discussions herein present example environments, systems, methods, and computer program products for discovery of knowledge base articles from a large customer support knowledge base.

### Overview

Disclosed herein are techniques for populating a specialized data structure with solution probability predictor parameter values to quickly and accurately identify knowledge base articles with the highest probability of addressing a particular customer support case. In certain embodiments, one or more knowledge base articles are identified as contributing to the resolution of each closed (e.g., resolved) customer support case. The articles and sets of words associated with each closed case are recorded in a set of mapping data.

The mapping data is analyzed to determine a solution probability predictor for each knowledge base article. The parameters of the solution probability predictors are stored in a specialized data structure that facilitates low latency access to the parameters. When a new case is initiated by a support engineer and/or a user, the words associated with the now active case are extracted from various sources. Such sources might include the text of an email, the text of a chat conversation, the text derived from a voice-to-text translation, and/or other sources. The extracted words associated with the active case are applied to the specialized data structure comprising the solution probability predictor parameter values to rank the knowledge base articles based at least in part on the results produced by the solution probability predictors.

Specifically, the knowledge base articles might be ranked based at least in part on their respective probabilities (e.g., as predicted by the solution probability predictors) of addressing the issue associated with the active case. The most relevant (e.g., top three) of the ranked knowledge base articles are presented to the support engineer and/or to the user. In certain embodiments, the specialized data structure is accessed using a hash function. In certain embodiments, the specialized data structure includes a fraction representation portion in a fixed-point precision bit field that is used in combination with a signed integer representation. In certain embodiments, the solution probability predictors are determined at least in part by applying a logistic regression technique. In certain embodiments, a selected portion of the mapping data is analyzed to determine the solution probability predictors.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### DESCRIPTIONS OF EXAMPLE EMBODIMENTS

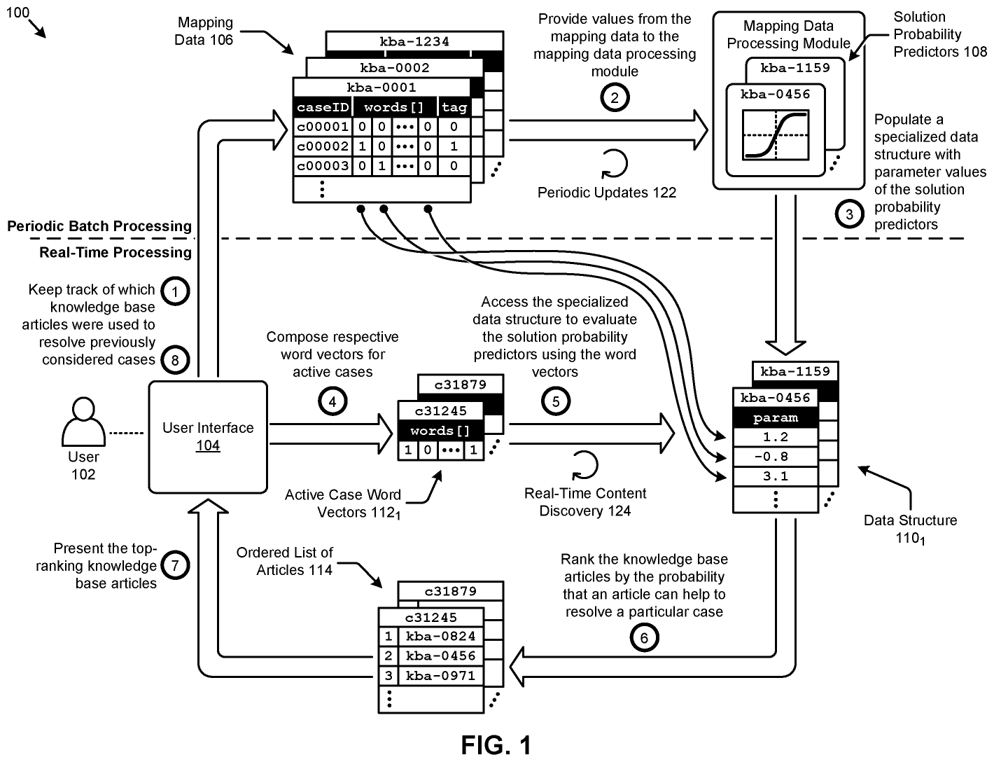

FIG. 1 illustrates a computing environment 100 in which embodiments of the present disclosure can be implemented. As an option, one or more variations of computing environment 100 or any aspect thereof may be implemented in the context of the architecture and functionality of the embodiments described herein.

FIG. 1 illustrates one aspect pertaining to populating a specialized data structure with solution probability predictor parameter values to quickly and accurately identify knowledge base articles with the highest probability of addressing a particular customer support case. Specifically, the figure presents a logical depiction of how the herein disclosed techniques can be implemented in a computing environment to perform real-time discovery of knowledge base articles from a large customer support knowledge base.

The logical depiction of FIG. 1 illustrates a user interface 104 that is accessed by a user 102. In some cases, the user 102 might be a computing system user or system administrator that invokes an instance of the user interface 104 to initiate active customer support cases pertaining to issues with the computing system. In other cases, user 102 might be a support engineer representing a computing system provider that invokes an instance of the user interface 104 to facilitate resolution of active customer support cases. In any case, real-time access to information that can facilitate resolution of a particular active customer support case is desired by user 102. More specifically, real-time discovery of knowledge base content (e.g., knowledge base articles) that is relevant to solving an active customer support case may facilitate a quick resolution of the case.

Unfortunately, when mature and prolific computing systems have thousands of knowledge base articles that are associated with tens of thousands of historical customer support cases (e.g., closed customer support cases), the computing resources consumed to identify relevant knowledge base content can be overwhelming. Furthermore, as the number of users (e.g., user 102) of such computing systems continues to grow (e.g., to tens of thousands of users or more), the latency associated with identifying relevant knowledge base content (e.g., to a user or support engineer) can increase commensurately, negatively impacting the user experience.

In the embodiment of FIG. 1, the herein disclosed techniques address such problems attendant to matching knowledge base articles to customer support cases at least in part by populating a data structure 1101 with parameters associated with instances of solution probability predictors 108 that correspond to a set of respective knowledge base articles. These parameters are accessed to form a probability function that in turn is used identify the knowledge base articles with the highest probability of addressing a particular active customer support case. In certain embodiments, the solution probability predictors 108 are based at least in part on the words associated with historical customer support cases that the knowledge base articles are known to have helped resolve.

Such techniques disclosed herein facilitate improvements in computer functionality that serve to more efficiently use the computing resources, memory resources, storage resources, networking resources, and/or other resources of distributed computing environments. Specifically, applications of the herein disclosed techniques eliminate the consumption of computing resources to perform exhaustive searches through large volumes of historical customer support cases and knowledge base content to discover knowledge base articles that might be relevant to each active customer support case. Furthermore, data as might be organized in computer memory (e.g., using the low-latency configuration of the shown data structure 1101) and as implemented in various embodiments of the herein disclosed techniques serves to improve the way a computer stores and retrieves data.

To facilitate the techniques disclosed herein, any known technique can be used to keep track of which knowledge base articles were used to resolve previously considered (e.g., closed) customer support cases (see operation 1). In some environments, previously closed customer support cases that were resolved at least in part by one or more knowledge base articles are tagged as being associated with such knowledge base articles. In other environments, a list or other compilation of closed cases and respective associations with particular knowledge base articles are maintained over time.

Using any such tagging or association techniques, sets of mapping data 106 for each knowledge base article (e.g., identified by “kba-0001”, “kba-0002”, . . . , “kba-1234”) might store the historical customer support cases, the words associated with the cases, and an indication (e.g., a “tag”) as to whether the knowledge base article was relevant to resolving each of the historical customer support cases. The mapping data 106 is accessed to generate a set of solution probability predictors 108 for at least a portion of the knowledge base articles (operation 2). Operations that serve to generate such solution probability predictors often consume a large amount of computing power—especially as the number of cases and the number of knowledge base articles grows—and accordingly might be performed only periodically (e.g., in periodically-occurring batch cycles) at a periodicity or rate that is much less often than operations that are carried out during real-time processing.

The aforementioned solution probability predictors facilitate determining a probability that a particular write-up of a solution (e.g., a knowledge base article) is relevant to resolving a particular problem (e.g., a customer support case). To keep the solution probability predictors in synchronization with the write-ups of solutions, the set of solution probability predictors are updated periodically (e.g., as indicated by periodic updates 122) in response to, for example, addition of a solution write-up or other change to mapping data 106.

All or selected portions of the mapping data might be processed, for example, generate solution probability predictors 108. The determination of whether to all or selected portions of the mapping data might depend on factors such as, whether or not the mapping data for a particular article is deemed to be complete, and/or whether or not a the mapping data for a particular article has a threshold number of corresponding cases that are solved by the article, etc.

During generation of the solution probability predictors, a specialized data structure (e.g., the shown data structure 1101) is populated with predictor parameter values (operation 3). The processes of operation 3 transform a plurality of values from specific columns of the mapping data 106 into a single corresponding value in a row of data structure 1101. Each row of data structure 1101 corresponds to a specific word from the mapping data. More specifically, the value in a row of data structure 1101 quantifies the extent that an occurrence of a corresponding specific word can be used in making predictions. As one example, the word “trouble” might be associated with a very low numeric value since it is likely that the word “trouble” would appear in any description of a problem or solution; thus, the occurrence of the word “trouble” does not serve as a strong predictor. As another example, the word “network” might be associated with a medium high value, since it is fairly likely that the word “network” would appear in any description of a problem or solution pertaining to a “network”, but it would be much less likely that the word “network” would appear in a description of a problem or solution pertaining to a “memory module socket”. Once the data structure 1101 is at least partially populated, any of the operations of the real-time processing (e.g., operation 4, operation 5, operation 6, operation 7, and operation 8) can be carried out.

In a specific non-limiting example, operation 4, operation 5, operation 6, operation 7, and operation 8 can be carried out to determine, in real-time, the knowledge base articles with the highest probability of addressing a particular active customer support case (e.g., real-time content discovery 124). The shown operation 4 serves to monitor activities pertaining to active customer support cases. Specifically, a repository of active customer support cases is continually monitored to identify new cases and to compose respective word vectors (e.g., sets of words) for the cases (operation 4). As can be observed, instances of active case words might be selected and used to compose the shown active case word vectors 1121. The composition of the shown active case word vectors serves to identify the presence of words that are associated with each of the active customer support cases. Also, the composition of the shown active case word vectors serves to identify the absence of words from the active customer support cases.

The data structure 1101 is accessed to facilitate evaluation of the solution probability predictors of the knowledge base articles using the active case word vectors 1121 (operation 5). Specifically, the predictor parameter values corresponding to the elements (e.g., words) of the active case word vectors 1121 are accessed with low-latency via the data structure 1101 to facilitate calculating the respective probability that each knowledge base article is relevant to resolving the active customer support cases associated with the active case word vectors 1121. The knowledge base articles are then ranked for each active customer support case according to the calculated probabilities (operation 6). As shown in one instance of the ordered list of articles 114, the top three knowledge base articles associated with active customer support case “c31245”, are ranked by the probabilities determined by the solution probability predictors. For case c31245, the top three articles are article “kba-0824”, article “kba-0456”, and article “kba-0971”. The top-ranking knowledge base articles are then presented (e.g., in user interface 104) to user 102 (operation 7). When any issue of the customer support case that is considered to have been resolved by one or more of the top-ranking knowledge base articles, an association between the case and the knowledge base articles that had served to resolve the issue is made (operation 8).

One embodiment of the herein disclosed techniques for real-time knowledge base content discovery is disclosed in further detail as follows.

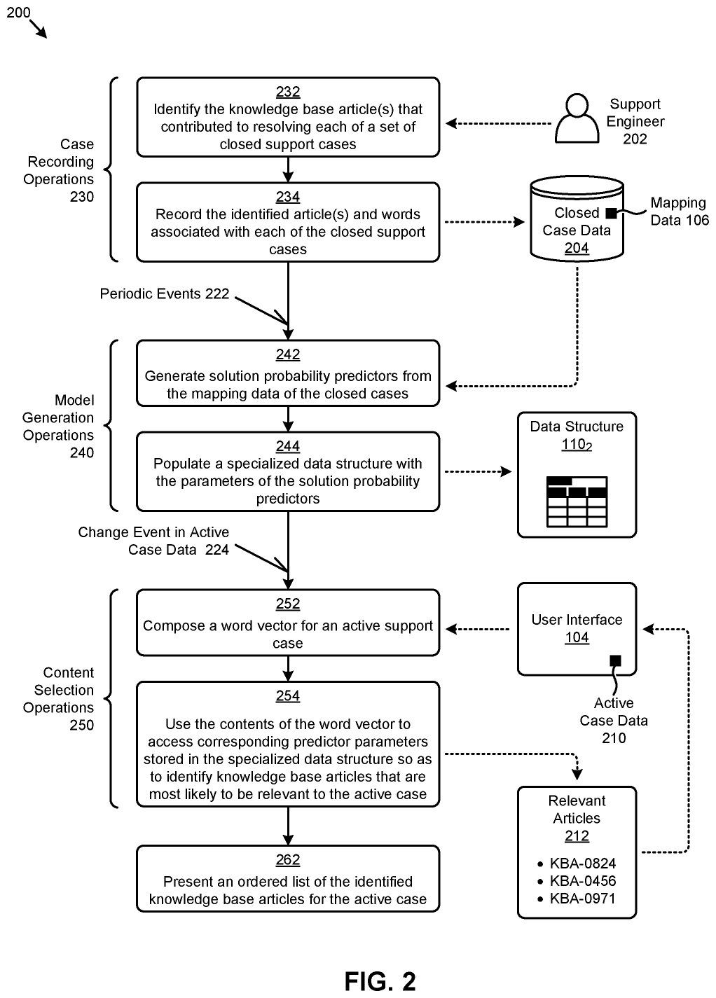

FIG. 2 depicts a knowledge base content discovery technique 200 as implemented in systems that facilitate real-time discovery of knowledge base articles from a large customer support knowledge base. As an option, one or more variations of knowledge base content discovery technique 200 or any aspect thereof may be implemented in the context of the architecture and functionality of the embodiments described herein. The knowledge base content discovery technique 200 or any aspect thereof may be implemented in any environment.

FIG. 2 illustrates one aspect pertaining to populating a specialized data structure with solution probability predictor parameter values to quickly identify knowledge base articles with the highest probability of addressing a particular customer support case. Specifically, the figure presents one embodiment of certain steps and/or operations that facilitate real-time discovery of knowledge base content (e.g., articles) from a large customer support knowledge base. As can be observed the steps and/or operations can be partitioned into a set of case recording operations 230, a set of model generation operations 240, and a set of content selection operations 250. Certain computing environment elements and/or components are also shown in the figure to illustrate an example application of the knowledge base content discovery technique 200.

The case recording operations 230 of the knowledge base content discovery technique 200 can commence by identifying the knowledge base article or articles that contributed to resolving each of a set of closed customer support cases (step 232). As illustrated, such associations between knowledge base articles and closed customer support cases might be specified by one or more customer support engineers (e.g., support engineer 202). The knowledge base articles and words associated with each closed customer support case are recorded (step 234). For example, the associations might be codified in instances of mapping data 106 that are stored in a set of closed case data 204.

A set of model generation operations 240 are invoked upon various periodic events 222. For example, the model generation operations 240 of the knowledge base content discovery technique 200 might commence in response to changes in the contents of the closed case data. As shown, step 242 serves to generate solution probability predictors from the mapping data 106. Specifically, the mapping data 106 stored in closed case data 204 might be accessed in response to an occurrence of an event corresponding to a newly-closed case for which its corresponding data is saved into the closed case data. In some embodiments each individual occurrence of such an event may trigger model generation operations 240, however in other embodiments, the generation operations 240 are triggered less frequently. For example, the generation operations 240 might be triggered once a week or once a day or once an hour, etc. The predictor parameter values that form the generated solution probability predictors are then stored in a specialized, low-latency access data structure (step 244). As one specific example, the predictor parameter values might be stored in one or more instances of a data structure 1102 to facilitate low-latency access to the parameter values.

The content selection operations 250 of the knowledge base content discovery technique 200 can commence by composing word vectors (e.g., sets of words) for a respective one or more active customer support cases (step 252). The word vectors might be initially composed or updated in response to one or more active case data changes 224. Such word vectors might comprise words derived from active case data 210 (e.g., case descriptions, case support dialog, etc.) that is captured and/or displayed at instances of user interface 104. The word vectors associated with the active customer support cases are used to access the predictor parameter values stored in the low-latency data structure to identify knowledge base articles that are relevant to the active cases (step 254). More specifically, for a particular active customer support case, the predictor parameter values that correspond to the word vector of the active case are applied to the solution probability predictors of each of the knowledge base articles to determine a respective probability value for the articles. In this case, the probabilities serve as a measure of the relevancy of the knowledge base articles in resolving the particular active customer support case. Ordered lists (e.g., ordered by probability value) of the identified knowledge base articles are presented (step 262). As an example, a set of relevant articles 212 comprising a list of articles (e.g., article “KBA-0824”, article “KBA-0456”, and article “KBA-0971”) ranked by probability value might be presented in real-time at the user interface 104.

One embodiment of a system for implementing the knowledge base content discovery technique 200 and/or other herein disclosed techniques is disclosed as follows.

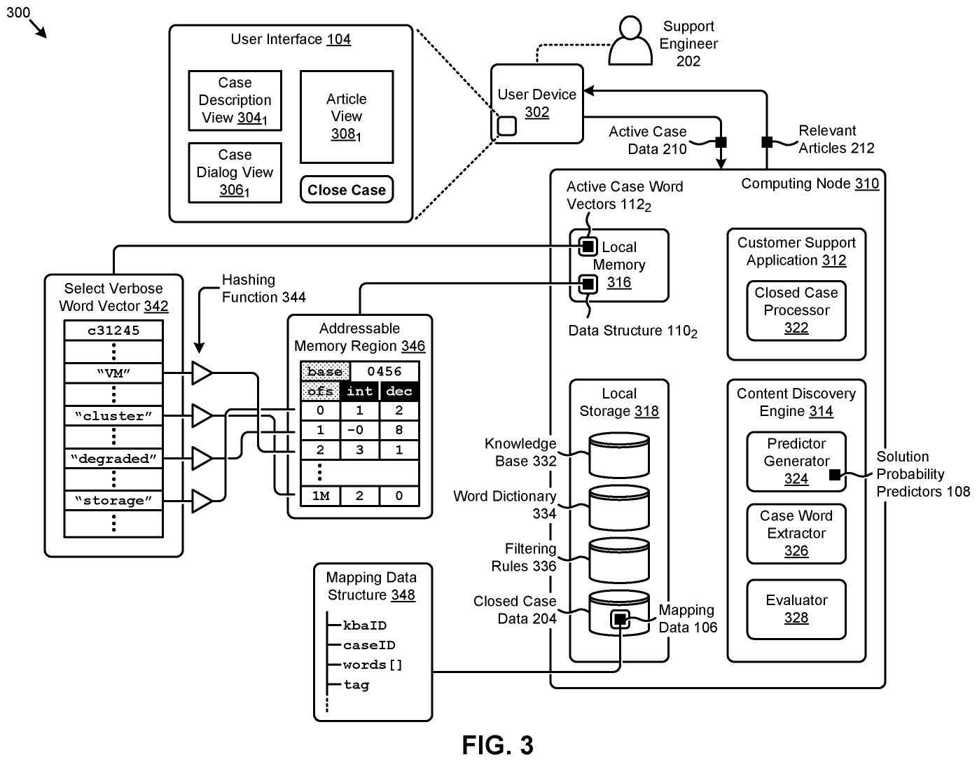

FIG. 3 illustrates a block diagram of a system 300 that facilitates real-time discovery of knowledge base articles from a large customer support knowledge base. As an option, one or more variations of system 300 or any aspect thereof may be implemented in the context of the architecture and functionality of the embodiments described herein. The system 300 or any aspect thereof may be implemented in any environment.

FIG. 3 illustrates one aspect pertaining to populating a specialized data structure with solution probability predictor parameter values to quickly identify knowledge base articles with the highest probability of addressing a particular customer support case. Specifically, the figure is being presented to show one embodiment of certain representative components and associated data structures and data flows that describes how the herein disclosed techniques might be implemented in a computing environment. Details of certain data structures are shown in FIG. 3 to illustrate how the data structures improve the way a computer stores and retrieves data in memory when performing steps pertaining to discovery of knowledge base articles from a large customer support knowledge base. The components, data structures, and data flows shown in FIG. 3 present one particular partitioning and a corresponding data manipulation approach. The specific example shown is purely exemplary, and other subsystems, data structures, and/or partitionings are reasonable.

As shown in FIG. 3, the system 300 comprises at least one instance of a computing node 310 that is interconnected with at least one instance of a user device 302. A customer support application 312 operating at computing node 310 presents a user interface 104 at user device 302 to facilitate management of one or more active customer support cases by support engineer 202. As shown, the user interface 104 at user device 302 presents a case description view 3041, a case dialog view 3061, and an article view 3081 to the support engineer 202. As an example, the case description view 3041 might present text and/or screenshots (e.g., entered by a system user or system administrator) that describe one or more issues associated with a particular active customer support case. The case dialog view 3061 might comprise a transcript of an email and/or chat conversation between support engineer 202 and one or more users or admins associated with the case. A “Close Case” button at user interface 104 is presented to support engineer 202 to invoke the closure of a resolved customer support case.

When a customer support case is closed, a closed case processor 322 at customer support application 312 receives an instance of active case data 210 that corresponds to the case being closed. Such active case data might comprise a word vector (e.g., set of words) associated with the case, as well as an associated set of one or more knowledge base articles from a knowledge base 332 that contributed to resolving the case. The closed case processor 322 processes the foregoing data to update the mapping data 106 in the closed case data 204, which is stored in local storage 318 at computing node 310.

As indicated by a mapping data structure 348, data records (e.g., a relational table row or programming object instance) comprising the mapping data 106 might associate a particular knowledge base article with various attributes related to the article. Specifically, a data record might comprise a knowledge base article identifier (e.g., stored in a “kbaID” field), a historical customer support case identifier (e.g., stored in a “caseID” field), a word vector identifying a set of words associated with the case (e.g., stored in a “words [ ]” object), a tag that indicates whether the knowledge base article was used to resolve the historical customer support case (e.g., stored in a “tag” field), and/or other attributes associated with the knowledge base article. The aforementioned set of words associated with the case might be processed against a set of word processing rules that serve to normalize natural language usage. Such processing operations can include stemming, correcting spelling errors, eliminating stop words, collapsing a larger set of pronouns into a smaller set of pronouns, collapsing a larger set of prepositions into a smaller set of prepositions, making words case insensitive, capturing word ordering, etc.

In certain embodiments, the “words [ ]” object comprises all the words from word dictionary 334, together with a binary “1” indication to indicate that a particular word is present in a particular case, and a binary “0” indication to indicate that a particular word is not present in a particular case. In other embodiments, a representation of the number of occurrences of a particular word in a particular case can be used, rather than the foregoing binary “1” or “0” indication. Strictly as examples, a representation of the number of occurrences of a particular word in a particular case can be quantified as the count itself (e.g., an integer value of the count) or by a scaled value of the count itself (e.g., log(count+1)), or by any other function of the count that serves to quantify a representation of a number of occurrences.

In certain embodiments, any changes to the mapping data 106 triggers a set of model training operations. Such model training operations might be carried out by a predictor generator 324 of a content discovery engine 314 at computing node 310. To perform the model training operations, predictor generator 324 accesses the mapping data 106 in local storage 318 to generate a set of solution probability predictors 108 for each of the knowledge base articles identified in mapping data 106. In some cases, a set of filtering rules 336 might be consulted to reduce the set of knowledge base articles for which a solution probability predictor is generated. The predictor generator 324 stores the predictor parameter values associated with the solution probability predictors in a specialized configuration of data structure 1102 that is stored in local memory 316 of computing node 310.

As depicted in the shown addressable memory region 346, each instance of the data structure 1102 can span a region of addressable memory located at a base address (e.g., indicated as address “0456”). Each instance of such a specialized data structure corresponds to a particular knowledge base article, and each entry can be addressed by adding the aforementioned base address to an offset, which entry corresponds to a particular word or ngram. For example, the word “degraded” might correspond to the entry at offset ‘1’, and the ngram “VM” might correspond to the entry at offset ‘2’.

The set of all words or ngrams found in any case description might be amalgamated to form a dictionary of possible words. In doing so, each unique word or ngram can be assigned to a respective offset. The assigned offsets are used across all word vectors. Such a set of assignments between words and offsets might be specified in a word dictionary 334, which can be stored in local storage 318.

In certain embodiments, a particular address offset that corresponds to a particular word might be generated at least in part by applying a hashing function 344 to the particular word. In this case, the data structure 1102 can be logically represented by a table. An access address or offset for a table entry corresponding to a particular word derives from a hash function output value after applying the hashing function to that particular word. The same hashing function 344 is applied to any word or ngram. Such a hashing function might be constructed such that the distribution of words to hashed values is uniform across the range of outputs of the hashing function.

The table entry in turn corresponds to a respective predictor parameter associated with the particular word. Using such a hashing function in combination with the foregoing specialized data structure serves to achieve retrieval of the predictor parameter values with a constant runtime complexity of “O(1)”. Furthermore, as illustrated in addressable memory region 346, the predictor parameter values might be partitioned and stored as two separately accessible components, specifically: (1) a signed integer component (e.g., stored in an “int” field) and a fractional or decimal component (e.g., stored in a “dec” field). As such, manipulations of the predictor parameter values can be performed using integer operations rather than floating point operations, reducing the computing resources and/or processing time required to perform the manipulations.

As further illustrated in addressable memory region 346, the address space of each region can be allocated to be a certain number of orders “P” greater than the order of the number of possible words so as to facilitate handling of hashing collisions. For example, if the number of words in word dictionary 334 is less than 2¹⁷ (or 128K), then the address space for each memory region corresponding to the knowledge base articles might comprise 2²⁰ (or 1 M) addresses. The hashing function 344 is also designed to avoid collisions within the allocated address space. More specifically, a hashing function can be designed to deliver a uniform distribution of output values given the full set of all possible words or ngrams. In the foregoing case of a sparsely-populated table and a hashing function that delivers uniform output values throughout the range of the table, the theoretical likelihood of a collision is approximately one in eight. The likelihood of a collision can be further reduced by selecting a suitably large value of ‘P’. In some embodiments, collisions can be ignored. Specifically, when there are a large number of words that comprise a dictionary, the loss of predictive accuracy due to some small number of collisions can be ignored.

Given the set of then-current solution probability predictors, one or more knowledge base articles that are relevant to resolving an active customer support case can be determined. As illustrated in FIG. 3, a case word extractor 326 operating at content discovery engine 314 can facilitate such determinations by generating one or more active case word vectors 1122 that correspond to the then-current active customer support cases. Each word in the word vectors of the active customer support cases is hashed to access the predictor parameter values of the knowledge base articles. For example, each word (e.g., “VM”, “cluster”, “degraded”, “storage”, etc.) of a select verbose word vector 342 from the active case word vectors 1122 is mapped (e.g., by hashing function 344) to a respective predictor parameter (e.g., 3.1, 2.0, −0.8, and 1.2, respectively) of a particular knowledge base article associated with base address “0456”. The predictor parameter values corresponding to the word vector are used by an evaluator 328 at content discovery engine 314 to calculate a probability that the aforementioned particular knowledge base article can resolve the active customer support case. The set of knowledge base articles with the highest probabilities (e.g., top three probabilities) are presented as a set of relevant articles 212 in the article view 3081 of the user interface 104.

The foregoing discussions include techniques for generating solution probability predictors for respective knowledge base articles (e.g., model generation operations 240 of FIG. 2), which techniques are disclosed in further detail as follows.

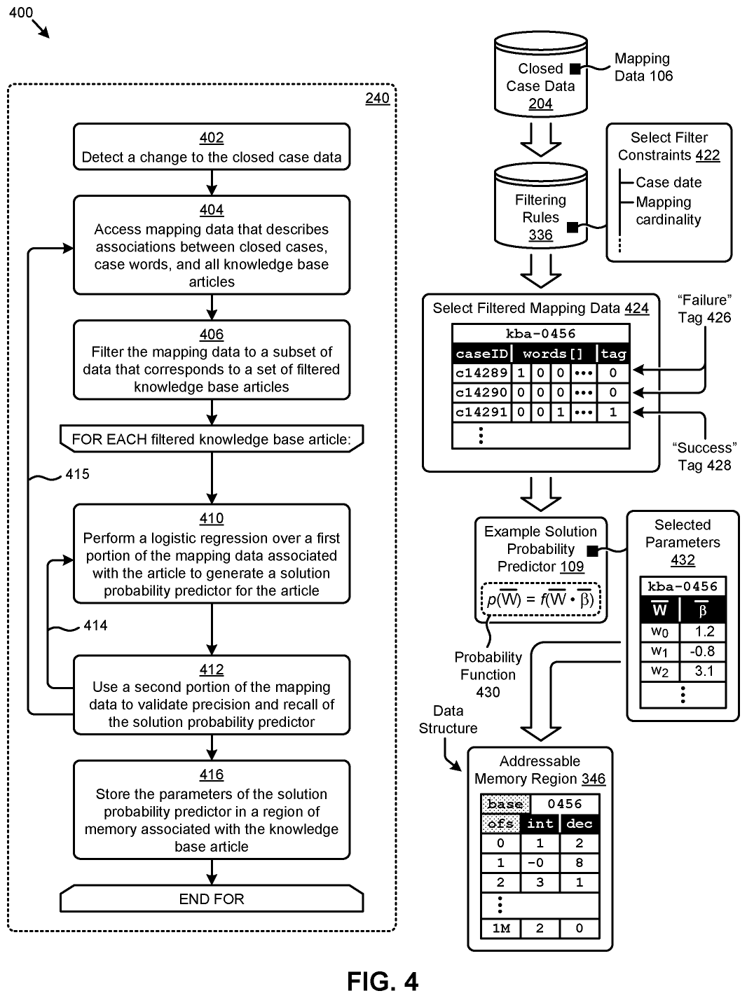

FIG. 4 presents a solution probability predictor generation technique 400 as implemented in systems that facilitate real-time discovery of knowledge base articles from a large customer support knowledge base. As an option, one or more variations of solution probability predictor generation technique 400 or any aspect thereof may be implemented in the context of the architecture and functionality of the embodiments described herein. The solution probability predictor generation technique 400 or any aspect thereof may be implemented in any environment.

FIG. 4 illustrates one aspect pertaining to populating a specialized data structure with solution probability predictor parameter values to quickly identify knowledge base articles with the highest probability of addressing a particular customer support case. Specifically, the figure is presented to illustrate one embodiment of certain steps and/or operations for generating solution probability predictors for respective knowledge base articles. A representative scenario is also shown in the figure to illustrate at least a portion of an example application of the solution probability predictor generation technique 400.

As shown in FIG. 4, the solution probability predictor generation technique 400 can commence by detecting a change to a set of closed case data associated with one or more closed customer support cases (step 402). A set of mapping data that describes associations between the closed customer support cases, the case words, and all available knowledge base articles is accessed (step 404). As illustrated, the mapping data earlier described might be accessed in response to a change to the mapping data 106 or another portion of the closed case data 204. The mapping data is filtered to form a subset of data that corresponds to a set of filtered knowledge base articles (step 406). The mapping data might be filtered for various purposes, such as to reduce processing latencies or improve the accuracy of the models generated by the solution probability predictor generation technique 400.

As can be observed, a set of filtering rules 336 might be consulted to facilitate the filtering of mapping data 106. A set of rules (e.g., rule base) such as filtering rules 336 or any other rules described herein, comprises data records storing various information that can be used to form one or more constraints to apply to certain functions and/or operations. For example, the information pertaining to a rule in the rule base might comprise the conditional logic operands (e.g., input variables, conditions, constraints, etc.) and/or operators (e.g., “if”, “then”, “and”, “or”, “greater than”, “less than”, etc.) for forming a conditional logic statement that returns one or more results. As shown in the set of select filter constraints 422, aspects pertaining to the “case date” or “mapping cardinality” (e.g., only select knowledge base articles mapped to one case) of mapping data 106 might be considered when filtering the data. As such, various heuristics (e.g., in the form of rules) can be applied to generate a smaller data set. The smaller data set can in turn be used to train predictors. Strictly as one non-limiting example, a selected plurality of cases from the closed case data can be selected by applying a rule that filters out cases that are, for example, older than one year.

The shown set of select filtered mapping data 424 of FIG. 4 as merely one representative example of the mapping data of a filtered knowledge base article (e.g., article “kba-0456”). As depicted in select filtered mapping data 424, a “success” tag 428 (e.g., a “1” in the “tag” field) is used to indicate a subject knowledge base article (e.g., article “kba-0456”) did contribute to resolving a particular case, whereas a “failure” tag 426 (e.g., a “0” in the “tag” field) is used to indicate the subject knowledge base article (e.g., article “kba-0456”) did not contribute to resolving that case.

For each of the filtered knowledge base articles, a logistic regression is performed over a portion of the mapping data associated with the article to train a solution probability predictor for the article (step 410). For example, a randomly-selected first portion of the mapping data might be used to train the predictors. A different portion of the mapping data might then be used to evaluate the accuracy of the trained predictors. Specifically, a second portion of the mapping data (e.g., a random sampling) is then applied to validate the solution probability predictors (step 412).

The processes of training and validating can be iterated (see path 414) until the solution probability predictor behaves within target tolerances (e.g., with respect to predictive statistic metrics, descriptive statistics, significance tests, etc.). With the foregoing logistic regression approach, the mapping data is analyzed to form a model that can predict “success” and “failure” case outcomes codified in the mapping data based at least on word vectors associated with each case. As such, the words of the word vectors are the independent variables (e.g., explanatory variables) of the model and the success/failure outcome is the dependent variable (e.g., response variable) of the model.

In some situations, path 415 is taken, where yet another, third portion of the mapping data is applied to train and validate the solution probability predictors. Quantities corresponding to the statistical measures of precision and recall are calculated for each of the solution probability predictors based on the second portion of the mapping data and the third portion of the mapping data, respectively. When the statistical measures of precision and recall from the second portion and the third portion are determined to be within target tolerances, then the predictors are deemed to be validated. The size of the second portion and the third portion that are used in the iterative training and validation (e.g., via path 414 and/or path 415) are selected to be large enough to develop predictors with high precision and recall (e.g., to avoid underfitting), yet small enough (e.g., to avoid overfitting) such that noise is not trained into the predictors.

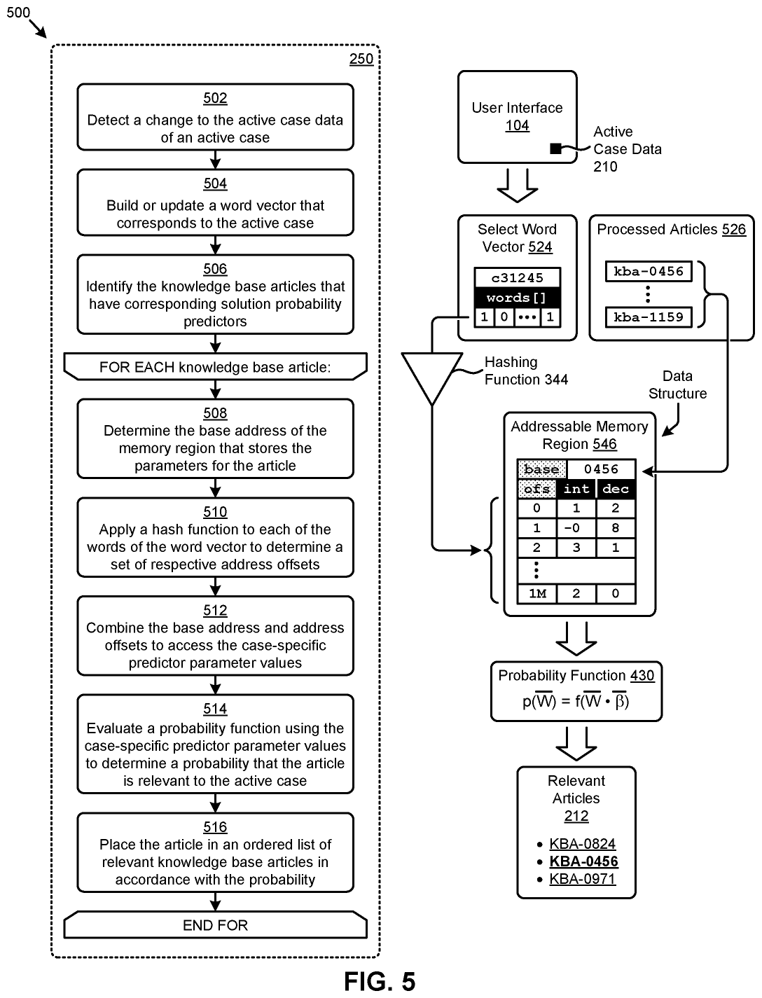

As depicted in the example solution probability predictor 109, the predictor can be represented by a probability function 430, which states that the probability p(W̅) that a knowledge base article is relevant (e.g., provides a “success” outcome) to an active customer support case with a word vector W̅ is a function of the sum-product of word vector W̅ and coefficient vector β̅. The sum-product (W̅·β̅) is often called the logistic regression expression. As illustrated by a set of select predictor parameters 432, the word vector W̅ and the coefficient vector \hat{β} can comprise the probability predictor parameter values of a particular solution probability predictor. Calculations other than the sum-product expression can be used. One such set of calculations is given in EQ. 1 as pertains to FIG. 5.

When the aforementioned predictor parameters are determined, they are stored in a region of memory associated with the knowledge base article (step 416). As illustrated, the addressable memory region 346 stores the select predictor parameters 432 in accordance with the shown low-latency data structure.

The operations carried out in the foregoing training and validating iterations serve to reduce a very large dataset (e.g., the mapping data) into a much smaller dataset (e.g., the parameters of the probability functions). Moreover, in the example embodiments discussed here, the resulting dataset is not only much smaller, but is organized in a data structure to be accessed by an address that is calculated by a hash function. As such, access to numeric values of the resulting dataset (e.g., as stored in the heretofore described data structure) can be achieved with a constant runtime complexity, which is much more efficient than any forms of searching and/or sorting. Still further, integer representation of both the integer portion as well as the fractional portion in the data structure for representing a floating point quantity delivers high performance computation, at least in that the computer does not have to perform complex and time-consuming floating point operations.

The foregoing discussions include techniques for real-time selection of relevant knowledge base content (e.g., content selection operations 250 of FIG. 2), some of which techniques are disclosed in further detail as follows.

FIG. 5 presents a knowledge base article ranking technique 500 as implemented in systems that facilitate real-time discovery of knowledge base articles from a large customer support knowledge base. As an option, one or more variations of knowledge base article ranking technique 500 or any aspect thereof may be implemented in the context of the architecture and functionality of the embodiments described herein. The knowledge base article ranking technique 500 or any aspect thereof may be implemented in any environment.

FIG. 5 illustrates one aspect pertaining to populating a specialized data structure with solution probability predictor parameter values to quickly identify knowledge base articles with the highest probability of addressing a particular customer support case. Specifically, the figure is presented to illustrate one embodiment of certain steps and/or operations for real-time selection and ranking of knowledge base articles based at least in part on the probability that the articles can help resolve a particular customer support case. A representative scenario is also shown in the figure to illustrate at least a portion of an example application of the knowledge base article ranking technique 500.

As shown in FIG. 5, the knowledge base article ranking technique 500 can commence by detecting a change to the active case data of an active customer support case (step 502). For example, a change to the active case data 210 (e.g., a user or support engineer types additional words or speaks additional words for automatic speech recognition) at an instance of user interface 104 might be detected. A word vector (e.g., select word vector 524) that corresponds to the active customer support case is composed (e.g., if a new case) or updated (step 504). Any knowledge base articles that have corresponding then-current solution probability predictors are identified (step 506). As can be observed in a set of processed articles 526, the knowledge base articles with corresponding solution probability predictors might include a range of articles between and including article “kba-0456” and article “kba-1159”.

For each of the knowledge base articles with solution probability predictors, the base address of the memory region storing the predictor parameter values of the knowledge base article is determined (step 508). As merely one example, the base address (e.g., “0456”) might be derived from the article identifier (e.g., “kba-0456”). A hashing function (e.g., hashing function 344) is applied to the words of the word vector (e.g., select word vector 524) of the active customer support case (e.g., case “c31245”) to determine a respective set of memory address offsets (step 510). The aforementioned base address and address offsets are combined to access the case-specific predictor parameter values of the knowledge base article (step 512). The addressable memory region 346 illustrated in FIG. 5 depicts how the base address and the address offsets are derived from the processed articles 526 and the select word vector 524, respectively.

Using the case-specific predictor parameter values, a probability function is evaluated to determine a probability that the article is relevant to the active case (step 514). Specifically, a coefficient vector \hat{β} derived from the “int” and “dec” fields of the addressable memory region 546 and a word vector W̅ derived from select word vector 524 for case “c31245” can be used to evaluate the probability function 430. In certain embodiments, probability function 430 might have the following form:

p(W̅)=[1+e^{-(W̅·β̅)}]⁻¹ (EQ. 1)

Based at least in part on the probability value produced by evaluating the probability function (e.g., probability function 430 or a function deriving from EQ. 1) against a word vector (e.g., select word vector 524) derived from the active case data, the article is placed in an ordered list of relevant knowledge base articles (step 516). As shown in relevant articles 212, the article “KBA-0456” depicted in the scenario of FIG. 5 might be placed in a second position based on the probability value associated with the article in comparison with the probability values of other knowledge base articles (e.g., article “KBA-0824” and article “KBA-0971”).

The foregoing discussions include techniques for real-time discovery of knowledge base content in response to changes to active case data, which techniques are disclosed in further detail as follows.

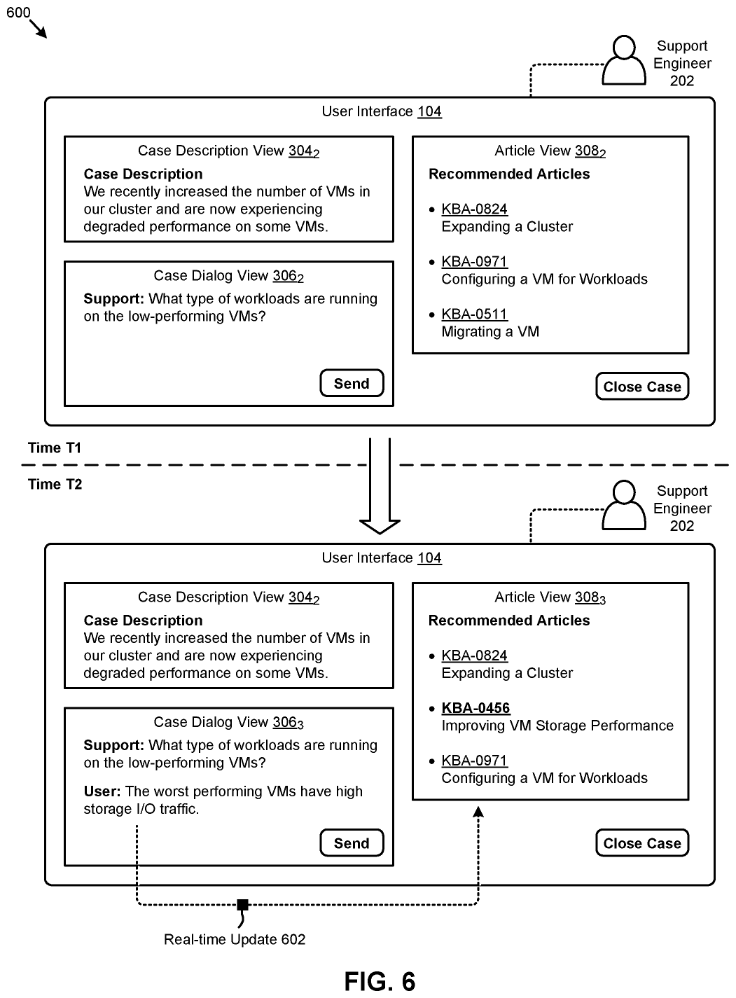

FIG. 6 presents a customer support center use scenario 600 as implemented in systems that facilitate real-time discovery of knowledge base articles from a large customer support knowledge base. As an option, one or more variations of customer support center use scenario 600 or any aspect thereof may be implemented in the context of the architecture and functionality of the embodiments described herein. The customer support center use scenario 600 or any aspect thereof may be implemented in any environment.

FIG. 6 illustrates one aspect pertaining to populating a specialized data structure with solution probability predictor parameter values to quickly identify knowledge base articles with the highest probability of addressing a particular customer support case. Specifically, the figure is being presented to illustrate a scenario that depicts a real-time update 602 of a list of recommended knowledge base articles in response to changes to certain active case data.

The customer support center use scenario 600 depicts two sets of views presented to support engineer 202 in user interface 104 at two respective moments in time (e.g., time T1 and time T2). At time T1, a case description view 304₂ and a case dialog view 306₂ comprise certain information (e.g., words) that are used by the herein disclosed techniques to generate the list of recommended knowledge base articles (e.g., article “KBA-0824”, article “KBA-0971”, and article “KBA-0511”) in an article view 308₂. The knowledge base articles in article view 308₂ are ranked by their respective probabilities of addressing the subject customer support case as described by the active case data derived from the case description view 304₂ and/or the case dialog view 306₂.

When a change to any of the active case data is detected, the herein disclosed techniques facilitate a real-time adjustment (if needed) to the ordered list of recommended articles. In the example scenario shown in FIG. 6, at time T2, a text response (e.g., “The worst performing VMs have high storage I/O traffic.”) from the “User” in case dialog view 306₃ invokes a real-time update 602 to the list of recommended articles in article view 308₃. Specifically, article “KBA-0456” is placed in the second position of the ordered list in article view 308₃. As indicated by its title “Improving VM Storage Performance”, article “KBA-0456” might have a high probability of resolving the subject customer support case as determined by the herein disclosed techniques since the user has indicated that the issue pertains to “storage” “performance”.

### Additional Embodiments of the Disclosure

### Additional Practical Application Examples

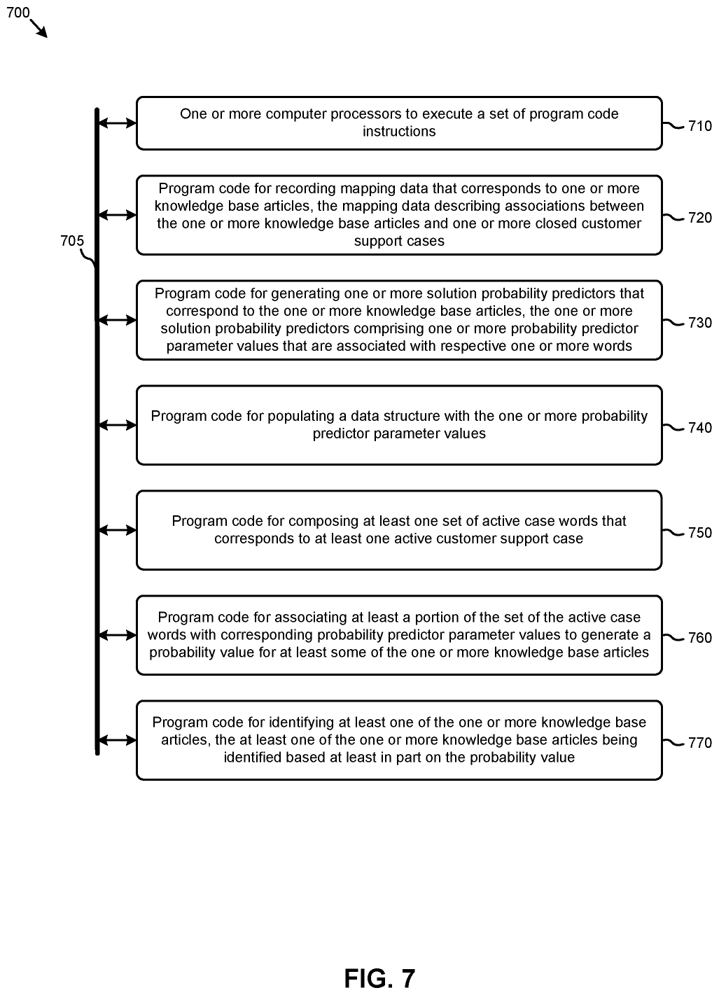

FIG. 7 depicts a system 700 as an arrangement of computing modules that are interconnected so as to operate cooperatively to implement certain of the herein-disclosed embodiments. This and other embodiments present particular arrangements of elements that, individually and/or as combined, serve to form improved technological processes that address quickly matching knowledge base articles to a customer support case. The partitioning of system 700 is merely illustrative and other partitions are possible. As an option, the system 700 may be implemented in the context of the architecture and functionality of the embodiments described herein. Of course, however, the system 700 or any operation therein may be carried out in any desired environment.

The system 700 comprises at least one processor and at least one memory, the memory serving to store program instructions corresponding to the operations of the system. As shown, an operation can be implemented in whole or in part using program instructions accessible by a module. The modules are connected to a communication path 705, and any operation can communicate with any other operations over communication path 705. The modules of the system can, individually or in combination, perform method operations within system 700. Any operations performed within system 700 may be performed in any order unless as may be specified in the claims.

The shown embodiment implements a portion of a computer system, presented as system 700, comprising one or more computer processors to execute a set of program code instructions (module 710) and modules for accessing memory to hold program code instructions to perform: recording mapping data that corresponds to one or more knowledge base articles, the mapping data describing associations between the one or more knowledge base articles and one or more closed customer support cases (module 720); generating one or more solution probability predictors that correspond to the one or more knowledge base articles, the one or more solution probability predictors comprising one or more probability predictor parameter values that are associated with respective one or more words (module 730); populating a data structure with the one or more probability predictor parameter values (module 740); composing at least one set of active case words that corresponds to at least one active customer support case (module 750); associating at least a portion of the set of the active case words with corresponding probability predictor parameter values to generate a probability value for at least some of the one or more knowledge base articles (module 760); and identifying at least one of the one or more knowledge base articles, the at least one of the one or more knowledge base articles being identified based at least in part on the probability value (module 770).

Variations of the foregoing may include more or fewer of the shown modules. Certain variations may perform more or fewer (or different) steps and/or certain variations may use data elements in more or in fewer (or different) operations. Still further, some embodiments include variations in the operations performed, and some embodiments include variations of aspects of the data elements used in the operations.

### System Architecture Overview

### Additional System Architecture Examples

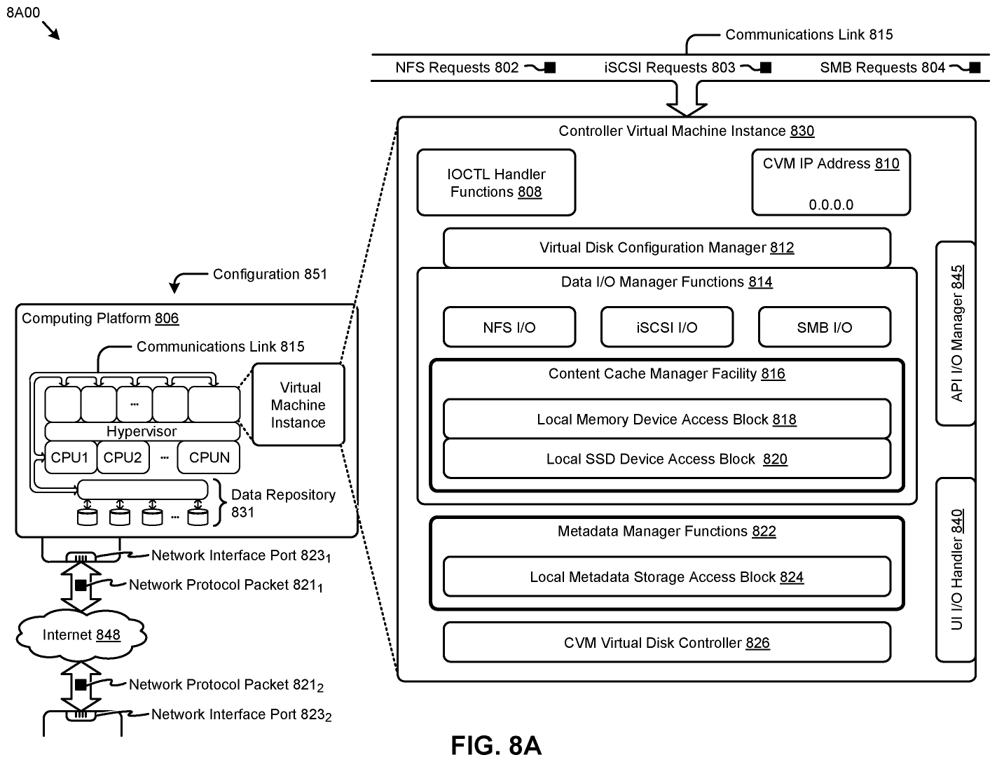

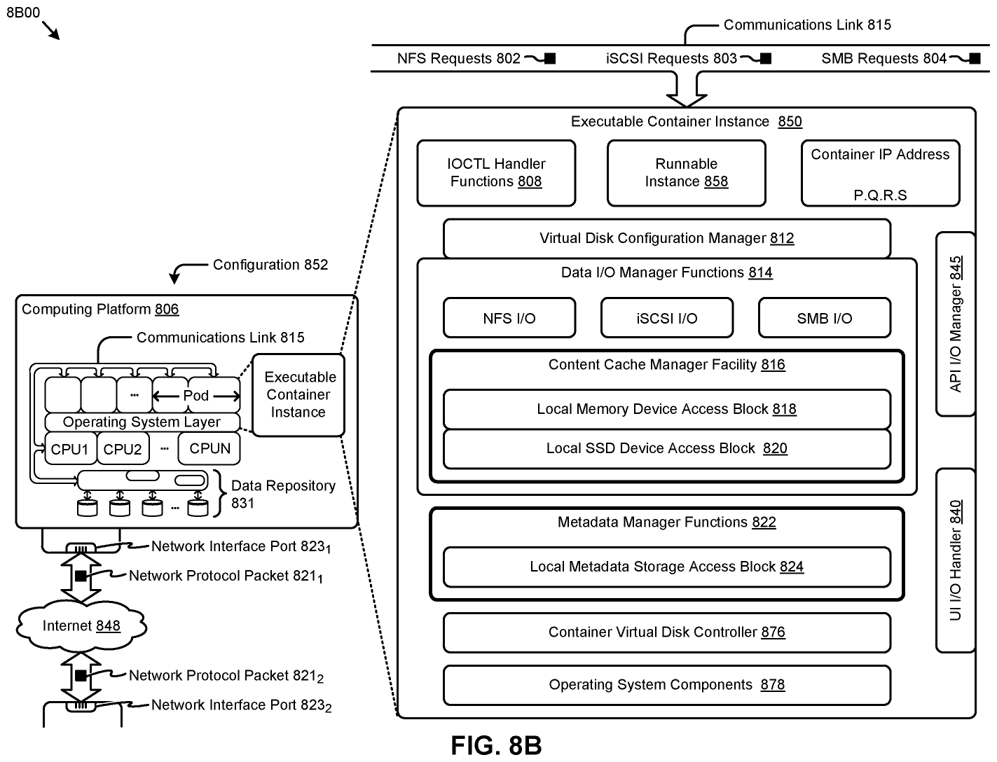

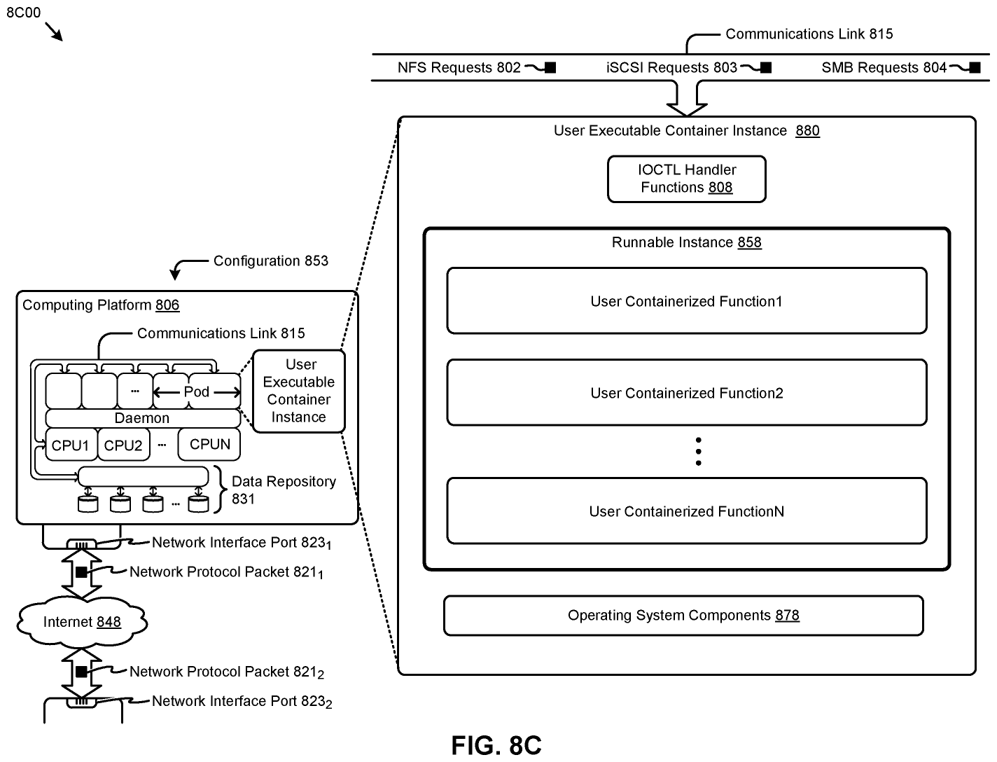

FIG. 8A depicts a virtualized controller as implemented by the shown virtual machine architecture 8A00. The heretofore-disclosed embodiments, including variations of any virtualized controllers, can be implemented in distributed systems where a plurality of networked-connected devices communicate and coordinate actions using inter-component messaging. Distributed systems are systems of interconnected components that are designed for, or dedicated to, storage operations as well as being designed for, or dedicated to, computing and/or networking operations. Interconnected components in a distributed system can operate cooperatively to achieve a particular objective, such as to provide high performance computing, high performance networking capabilities, and/or high performance storage and/or high capacity storage capabilities. For example, a first set of components of a distributed computing system can coordinate to efficiently use a set of computational or compute resources, while a second set of components of the same distributed storage system can coordinate to efficiently use a set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

As shown, virtual machine architecture 8A00 comprises a collection of interconnected components suitable for implementing embodiments of the present disclosure and/or for use in the herein-described environments. Moreover, virtual machine architecture 8A00 includes a virtual machine instance in configuration 851 that is further described as pertaining to controller virtual machine instance 830. Configuration 851 supports virtual machine instances that are deployed as user virtual machines, or controller virtual machines or both. Such virtual machines interface with a hypervisor (as shown). Some virtual machines include processing of storage I/O (input/output or IO) as received from any or every source within the computing platform. An example implementation of such a virtual machine that processes storage I/O is depicted as 830.

In this and other configurations, a controller virtual machine instance receives block I/O (input/output or IO) storage requests as network file system (NFS) requests in the form of NFS requests 802, and/or internet small computer storage interface (iSCSI) block IO requests in the form of iSCSI requests 803, and/or Samba file system (SMB) requests in the form of SMB requests 804. The controller virtual machine (CVM) instance publishes and responds to an internet protocol (IP) address (e.g., CVM IP address 810). Various forms of input and output (I/O or IO) can be handled by one or more IO control handler functions (e.g., IOCTL handler functions 808) that interface to other functions such as data IO manager functions 814 and/or metadata manager functions 822. As shown, the data IO manager functions can include communication with virtual disk configuration manager 812 and/or can include direct or indirect communication with any of various block IO functions (e.g., NFS IO, iSCSI IO, SMB IO, etc.).

In addition to block IO functions, configuration 851 supports IO of any form (e.g., block IO, streaming IO, packet-based IO, HTTP traffic, etc.) through either or both of a user interface (UI) handler such as UI IO handler 840 and/or through any of a range of application programming interfaces (APIs), possibly through API IO manager 845.

Communications link 815 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or persistent random access memories (RAPMs) or optical or magnetic media drives such as paper tape or magnetic tape drives. Volatile media includes dynamic memory such as random access memory. As shown, controller virtual machine instance 830 includes content cache manager facility 816 that accesses storage locations, possibly including local dynamic random access memory (DRAM) (e.g., through local memory device access block 818) and/or possibly including accesses to local solid state storage (e.g., through local SSD device access block 820).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of data repository 831, which in turn can be formatted into any one or more storage areas, and which can comprise parameterized storage accessible by a key (e.g., a filename, a table name, a block address, an offset address, etc.). Data repository 831 can store any forms of data, and may comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 824. The data repository 831 can be configured using CVM virtual disk controller 826, which can in turn manage any number or any configuration of virtual disks.

Execution of the sequences of instructions to practice certain embodiments of the disclosure are performed by one or more instances of a software instruction processor, or a processing element such as a data processor, or such as a central processing unit (e.g., CPU1, CPU2, . . . , CPUN). According to certain embodiments of the disclosure, two or more instances of configuration 851 can be coupled by communications link 815 (e.g., backplane, LAN, PSTN, wired or wireless network, etc.) and each instance may perform respective portions of sequences of instructions as may be required to practice embodiments of the disclosure.

The shown computing platform 806 is interconnected to the Internet 848 through one or more network interface ports (e.g., network interface port 8231 and network interface port 8232). Configuration 851 can be addressed through one or more network interface ports using an IP address. Any operational element within computing platform 806 can perform sending and receiving operations using any of a range of network protocols, possibly including network protocols that send and receive packets (e.g., network protocol packet 8211 and network protocol packet 8212).

Computing platform 806 may transmit and receive messages that can be composed of configuration data and/or any other forms of data and/or instructions organized into a data structure (e.g., communications packets). In some cases, the data structure includes program code instructions (e.g., application code) communicated through the Internet 848 and/or through any one or more instances of communications link 815. Received program code may be processed and/or executed by a CPU as it is received and/or program code may be stored in any volatile or non-volatile storage for later execution. Program code can be transmitted via an upload (e.g., an upload from an access device over the Internet 848 to computing platform 806). Further, program code and/or the results of executing program code can be delivered to a particular user via a download (e.g., a download from computing platform 806 over the Internet 848 to an access device).

Configuration 851 is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

A module as used herein can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to discovery of knowledge base articles from a large customer support knowledge base. In some embodiments, a module may include one or more state machines and/or combinational logic used to implement or facilitate the operational and/or performance characteristics pertaining to discovery of knowledge base articles from a large customer support knowledge base.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of discovery of knowledge base articles from a large customer support knowledge base). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to discovery of knowledge base articles from a large customer support knowledge base, and/or for improving the way data is manipulated when performing computerized operations pertaining to populating a specialized data structure with solution probability predictor parameter values to quickly identify knowledge base articles with the highest probability of addressing a particular customer support case.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT”, issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT”, issued on Oct. 1, 2013, which is hereby incorporated by reference in its entirety.

FIG. 8B depicts a virtualized controller implemented by containerized architecture 8B00. The containerized architecture comprises a collection of interconnected components suitable for implementing embodiments of the present disclosure and/or for use in the herein-described environments. Moreover, the shown containerized architecture 8B00 includes an executable container instance in configuration 852 that is further described as pertaining to executable container instance 850. Configuration 852 includes an operating system layer (as shown) that performs addressing functions such as providing access to external requestors via an IP address (e.g., “P.Q.R.S”, as shown). Providing access to external requestors can include implementing all or portions of a protocol specification (e.g., “http:”) and possibly handling port-specific functions.

The operating system layer can perform port forwarding to any executable container (e.g., executable container instance 850). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance (e.g., a Docker container instance) can serve as an instance of an application container or as a controller executable container. Any executable container of any sort can be rooted in a directory system, and can be configured to be accessed by file system commands (e.g., “ls” or “ls-a”, etc.). The executable container might optionally include operating system components 878, however such a separate set of operating system components need not be provided. As an alternative, an executable container can include runnable instance 858, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 876. Such a container virtual disk controller can perform any of the functions that the aforementioned CVM virtual disk controller 826 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 8C depicts a virtualized controller implemented by a daemon-assisted containerized architecture 8C00. The containerized architecture comprises a collection of interconnected components suitable for implementing embodiments of the present disclosure and/or for use in the herein-described environments. Moreover, the shown daemon-assisted containerized architecture includes a user executable container instance in configuration 853 that is further described as pertaining to user executable container instance 880. Configuration 853 includes a daemon layer (as shown) that performs certain functions of an operating system.

User executable container instance 880 comprises any number of user containerized functions (e.g., user containerized function1, user containerized function2, . . . , user containerized functionN). Such user containerized functions can execute autonomously, or can be interfaced with or wrapped in a runnable object to create a runnable instance (e.g., runnable instance 858). In some cases, the shown operating system components 878 comprise portions of an operating system, which portions are interfaced with or included in the runnable instance and/or any user containerized functions. In this embodiment of a daemon-assisted containerized architecture, the computing platform 806 might or might not host operating system components other than operating system components 878. More specifically, the shown daemon might or might not host operating system components other than operating system components 878 of user executable container instance 880.

The virtual machine architecture 8A00 of FIG. 8A and/or the containerized architecture 8B00 of FIG. 8B and/or the daemon-assisted containerized architecture 8C00 of FIG. 8C can be used in any combination to implement a distributed platform that contains multiple servers and/or nodes that manage multiple tiers of storage where the tiers of storage might be formed using the shown data repository 831 and/or any forms of network accessible storage. As such, the multiple tiers of storage may include storage that is accessible over communications link 815. Such network accessible storage may include cloud storage or networked storage (e.g., a SAN or “storage area network”). Unlike prior approaches, the presently-discussed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices, such as SSDs or RAPMs, or hybrid HDDs or other types of high-performance storage devices.

In example embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

Any one or more of the aforementioned virtual disks (or “vDisks”) can be structured from any one or more of the storage devices in the storage pool. As used herein, the term vDisk refers to a storage abstraction that is exposed by a controller virtual machine or container to be used by another virtual machine or container. In some embodiments, the vDisk is exposed by operation of a storage protocol such as iSCSI or NFS or SMB. In some embodiments, a vDisk is mountable. In some embodiments, a vDisk is mounted as a virtual storage device.

In example embodiments, some or all of the servers or nodes run virtualization software. Such virtualization software might include a hypervisor (e.g., as shown in configuration 851 of FIG. 8A) to manage the interactions between the underlying hardware and user virtual machines or containers that run client software.

Distinct from user virtual machines or user executable containers, a special controller virtual machine (e.g., as depicted by controller virtual machine instance 830) or as a special controller executable container is used to manage certain storage and I/O activities. Such a special controller virtual machine is referred to as a “CVM”, or as a controller executable container, or as a service virtual machine “SVM”, or as a service executable container, or as a “storage controller”. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors—thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

In the foregoing specification, the disclosure has been described with reference to specific embodiments thereof. It will however be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

1. A method for knowledge base content discovery, comprising:
recording mapping data that identifies an association to a description of a problem;
generating a solution probability predictor, the solution probability predictor having a probability predictor parameter value associated with a respective word;
generating a probability value that correlates the respective word with a problem description word; and
identifying an article, the article being identified based at least in part on the probability value.

2. The method of claim 1, further comprising populating a data structure with the probability predictor parameter value, wherein the data structure comprises at least one of, a table, a signed integer column, or a fractional portion column.

3. The method of claim 1, further comprising evaluating a hashing function.

4. (canceled)

5. The method of claim 1, wherein the probability predictor parameter value is determined based at least in part by performing a logistic regression over the mapping data.

6. The method of claim 1, wherein the solution probability predictor is described by a probability function.

7. (canceled)

8. The method of claim 1, wherein the article corresponds to a knowledge base article.

9. (canceled)

10. The method of claim 1, wherein the respective word is composed from at least one of, a description of the problem, an email associated with the problem, or a chat transcript associated with the problem.

11. A non-transitory computer readable medium having stored thereon a sequence of instructions which, when stored in memory and executed by a processor causes the processor to perform a set of acts for knowledge base content discovery, the acts comprising:
recording mapping data that identifies an association to a description of a problem;
generating a solution probability predictor, the solution probability predictor having a probability predictor parameter value associated with a respective word;
generating a probability value that correlates the respective word with a problem description word; and
identifying an article, the article being identified based at least in part on the probability value.

12. The computer readable medium of claim 11, further comprising populating a data structure with the probability predictor parameter value, wherein the data structure comprises at least one of, a table, a signed integer column, or a fractional portion column.

13. The computer readable medium of claim 11, further comprising instructions which, when stored in memory and executed by the processor causes the processor to perform acts of evaluating a hashing function.

14. (canceled)

15. The computer readable medium of claim 11, wherein the probability predictor parameter value is determined based at least in part by performing a logistic regression over the mapping data.

16. The computer readable medium of claim 11, wherein the solution probability predictor is described by a probability function.

17. (canceled)

18. The computer readable medium of claim 11, wherein the article corresponds to a knowledge base article.

19. A system for knowledge base content discovery, comprising:
a storage medium having stored thereon a sequence of instructions; and
a processor that execute the instructions to cause the processors to perform a set of acts, the acts comprising,
recording mapping data that identifies an association to a description of a problem;
generating a solution probability predictor, the solution probability predictor having a probability predictor parameter value associated with a respective word;
generating a probability value that correlates the respective word with a problem description word; and
identifying an article, the article being identified based at least in part on the probability value.

20. The system of claim 19, further comprising populating a data structure with the probability predictor parameter value, wherein the data structure comprises at least one of, a table, a signed integer column, or a fractional portion column.

21. The system of claim 19, wherein an active case word is generated that corresponds to a problem description, and the active case word is associated with a corresponding probability predictor parameter value to generate the probability value.

22. The system of claim 19, wherein the article corresponds to a knowledge base article.

23. The system of claim 19, wherein the probability predictor parameter value is determined based at least in part by performing a logistic regression over the mapping data.

24. The method of claim 1, wherein an active case word is generated that corresponds to a problem description, and the active case word is associated with a corresponding probability predictor parameter value to generate the probability value.

25. The computer readable medium of claim 11, wherein an active case word is generated that corresponds to a problem description, and the active case word is associated with a corresponding probability predictor parameter value to generate the probability value.
